(19) United States
(12) Patent Application Publication
(10) Pub. No.: US 2007/0228028 A1
(43) Pub. Date: Oct. 4, 2007

(54) Method for the Electrical Insulation of an Electrical Functional Element and a Device Having Such Insulated Functional Elements

(76) Inventors: Roland Starck, Bellheim (DE); Franz Flick, Offenbach (DE)

Correspondence Address: PATENTANWAELTE LICHTI + PARTNER GBR, POSTFACH 41 07 60, D-76207, KARLSRUHE, DE

(21) Appl. No.: 11/579,394

(22) PCT Filed: May 4, 2005
(86) PCT No.: PCT/EP05/04866

§ 371 Date: Nov. 2, 2006

(30) Foreign Application Priority Data
May 4, 2004 (DE) 10 2004 021979.6

(51) Int. Cl. B60L 1/00

(52) U.S. Cl. 219/204

(57) ABSTRACT

A method for the electrical insulation of an arrangement with an electrical functional element, such as a PTC element or a thermoelectric functional element is proposed, which is placed on a fastening part or in an electrically conductive casing. The inventive method is characterized in that the functional element together with the at least one connection, accompanied by the hollowing out of at least one contact surface to the fastening part, is so surrounded with an electrically insulating material that the latter engages on the fastening part or in the casing all around the contact surface. Thus, in a design and manufacturing simple manner, e.g. by extrusion, a comprehensive sealing of the electrical functional element can be achieved, so that during a subsequent covering with a material having a certain electrical conductivity, no shorting links are formed between the electrical connections of the functional element and the reference potential.

The invention relates to a method for the electrical insulation of an arrangement with at least one electrical functional element, such as a PTC heating element or a thermoelectric functional element, which is placed on an electrically conductive fastening part or in an electrically conducting casing and is provided with at least one electrical connection insulated against the fastening part. The invention also relates to a temperature control device having an arrangement with a thermoelectric functional element and electrical connection and contact means contacting the same, as well as an apparatus with such a temperature control device and a fastening part for placing the temperature control device in operative connection with an object to be temperature controlled. The invention finally relates to uses of such an apparatus.

In the car sector great efforts have been made in the past to increase the travelling comfort of a user by planned influencing of the climatic conditions in the vehicle interior, e.g. by providing air conditioning systems, seat heaters, additional heaters for heating the interior, even in the case of low ambient temperatures.

As a result of the increased heat feeling resulting from direct body contact particular significance is attached to the temperature control of objects with which the user comes into more or less direct contact. Therefore efforts have been made in the past to temperature control in a tactile pleasant manner objects directly contacted by the user in the vehicle interior, such as a steering wheel, e.g. under winter conditions. A suitable material (plastic) is moulded round the steering wheel and at least has a certain electrical conductivity, so that e.g. electrostatic charges can be avoided. However, the material more particularly has a good thermal conductivity in order to uniformly distribute heat over the steering wheel surface.

In known applications of this type an electrically conductive foil or fabric has been wound around a steering wheel base and subsequently provided with a covering contacted by the user and whose electrical power dissipation was used for steering wheel heating. It is considered disadvantageous in this connection that the PTC effect regularly desired with such applications and which permits a self regulating heating behaviour only exists to a greatly limited extent. In addition, said foil or fabric can easily be damaged, particularly as steering wheels leather is often subsequently manually sewn around the same.

It is also considered disadvantageous when using foil or fabric heating elements that
a temperature sensor and a control element are required, because the heating foil or fabric is not self regulating, said elements having to be fitted to the steering wheel, which is prejudicial to the haptics;
the application by adhesion is complicated;
on covering the steering wheel (in the form of a circular tube) with the planar foil or fabric bubbles or folds often arise and lead to high part rejects rate;
as a result of the constant heating capacity poor heating dynamics exist.

As the heat-conducting covering, which must also have pleasant tactile characteristics for the user, regularly use is made of plastics containing graphite or metal powder, with which the steering wheel and said heating elements, together with their electrical terminals, are moulded round in one piece.

It is particularly disadvantageous that the good heat conducting covering material generally also has a relatively good electrical conductivity, so that on covering the electrical heating elements and their terminals, it is possible for conductive connections to occur between components at different potentials (short-circuit), which is prejudicial to the usability of such means.

In view of the aforementioned prior art the problem of the invention is to so further develop a method of the aforementioned type that a reliable electrical insulation of the electrical functional element is possible. A further problem of the invention is to provide a temperature control device and an apparatus having such a temperature control device avoiding the aforementioned disadvantages of known devices.

In the case of a method of the aforementioned type, the problem is solved in that the functional element together with the at least one connection, accompanied by the hollowing out of at least one contact surface with the fastening part, is surrounded by an electrically insulating material in such a way that the latter all around the contact surface is in engagement with the fastening part or in the casing. The problem is also solved by a method in which the functional element together with the at least one connection, accompanied by the hollowing out of at least one contact surface relative to the fastening part, is surrounded with an electrically insulating material in such a way that the latter all around the contact surface engages with the fastening part or in the casing. The contacting of the functional element with the fastening part or casing can take place directly or indirectly. Thus, in an alternative development the contact surface is part of the surface of the functional element or the contact surface is placed on a contact plate forming the side of part of the arrangement remote from the functional element. The electrically insulating material surrounding over its entire circumference the contact surface of the electrical functional element creates a type of sealing lip efficiently preventing following the assembly of a functional element on the fastening part on moulding round with material having at least a certain electrical conductivity, the latter can penetrate between the fastening part, which is at a reference potential, typically earth potential, and the electrical connection of the functional element and leads to a short-circuit there.

According to a preferred development of the method, the functional element is placed in a hollow reception area of the fastening element or casing or is preferably formed in a casing constructed with the fastening part.

To ensure the aforementioned sealing action in a highly efficient manner, according to a preferred development of the inventive method, over its entire circumference, prior to an assembly of the functional element, particularly on the fastening part or casing, the contact surface is projected over by the electrically insulating material and preferably electrically insulating material projects over the contact surface in the direction of a surface normal thereof. In particular, according to the invention, a contact element, connected to the electrical connection, for the functional element for the formation of a sealing lip is moulded round with the electrically insulating material and also the electrical connection of the functional element can be moulded round with the electrically insulating material, optionally in one piece, i.e. in particular in one operation together with the contact element for the functional element.

To ensure an optimum sealing action of the insulating material projecting over the functional surface, according to a particularly preferred development of the inventive method, the functional element is brought into the arrangement of contact element and/or the at least one connection and the moulded insulating material. It is also advantageous if subsequently the functional element together with the surrounding insulating material and optionally the contact element is brought into a reception area in the fastening part or casing after which there is preferably an extrusion of the functional element together with the surrounding insulating material and optionally the contact element and fastening part of the casing, the material projecting over the contact surface being at least partly elastically deformed, so that the contact surface engages on the fastening part or casing.

The set problem is also solved by a temperature control device with an arrangement having a thermal functional element and electrical connection and contact means contacting the same, in which the thermal functional element and the connection and contact means, accompanied by the hollowing out of a contact surface of the arrangement, are surrounded by an electrically insulating material and surrounds the entire contact surface circumference in a plane parallel thereto as at least one sealing lip.

According to a preferred development, the contact surface is part of the surface of the functional element and in particular the sealing lip sealingly engages on a contact place covering the functional element. It is also possible to position the contact surface on the contact plate forming part of the arrangement on the side remote from the functional element.

According to a further development of the inventive temperature control device, prior to extrusion in a fastening part or a casing, the electrically insulating material projects over the entire circumference of the contact surface and the sealing lip preferably projects over the contact surface substantially in the direction of a surface normal. This makes it possible to achieve an efficient sealing action of the sealing lip particularly with the frequently encountered flat contact surfaces. For the same reason, the material projecting over the contact surface is preferably at least partly elastically deformable.

According to a preferred development, there are several sealing lips, preferably two lips, which are parallel to one another in order to reinforce the inventive sealing action.

In order to ensure a comprehensive sealing of both the thermal functional element and the connection and contact means, according to a preferred development of the inventive temperature control device, the thermal functional element and the connection and contact means are integrally surrounded by the electrically insulating material. For bringing about an electrical insulating action, at least the sealing lip is preferably formed in a plastic, which can in particular be a liquid crystal polymer (LCP). However, it is also possible to use other, injection mouldable polymers, such as polyamide, polyphenylene sulphide (PPS) or polymer ceramic.

To bring about a heating action by means of the inventive temperature control device, the latter has as a thermal functional element at least one PTC heating element.

For solving the set problem, the invention also provides an apparatus with an inventive temperature control device and a fastening part or a casing for bringing the temperature control device into operative connection with an object to be temperature controlled. In a preferred development, the functional element is placed in a reception area of a fastening part or the casing.

Such an apparatus can also be characterized in that the fastening part or casing is made from a good heat conducting material, such as aluminium, copper or their alloys, so that a heating or cooling action of the thermal functional element can act efficiently via the fastening part or casing on the object to be temperature controlled. For this purpose the apparatus according to the invention preferably has a reception area for the temperature control device in the fastening part or casing. The reception area is preferably constructed in the form of a cavity, so that after reception in the fastening part or casing, the temperature control device is surrounded on all sides by the fastening part or casing, with the exception of a reception opening. In particularly preferred manner the fastening part or casing is constructed as an extruded section, so that there is a further reception area opening in addition to the reception opening.

In order to bring about a very intimate contact between temperature control device and fastening part or casing in order to ensure an efficient heat transfer, according to a preferred development of the inventive apparatus, they can be joined and in particular extruded together. Thus, in the present invention it is possible to create an apparatus which is characterized in that the connection of temperature control device and fastening part or casing is tight with respect to a pressure which is higher than ambient pressure. This is particularly decisive if the temperature control device and fastening part or casing are to be subsequently provided with an at least also electrically conductive covering.

For the efficient connection of the inventive apparatus with an object to be temperature controlled, the fastening part or casing is preferably constructed as a clip and in a highly, preferred development of the inventive apparatus has first and second legs for the at least partial embracing of an object to be connected to the apparatus. Particularly if this object is an optionally fluid-filled tube, the legs can have a substantially pitch circular construction and can optionally taper towards their free ends. It is thus possible to place the fastening part or casing in force fit manner on an object to be connected to the apparatus.

According to further extending, alternative developments of the inventive apparatus, either the fastening part or the casing can be fixed to the object by extruding the legs therewith and e.g. also parts of the object can embrace the legs, so that the fastening part or casing can be fixed to the object by holding means provided thereon, or at the free end of the legs is in each case provided holding means for a clamping means for fixing the fastening part or casing to an object to be connected to the apparatus. According to the invention, the holding means can in particular be a thickening for holding a spring serving as clamping means.

The connection to a reference potential (earthing) necessary for safety reasons, preferably takes place in the inventive apparatus in such a way that the fastening part or casing has a connecting means for a further electrical connector for connecting to a reference potential.

An inventive apparatus is particularly suitable for heating a fluid carried in a pipeline or for heating a fluid in a pipeline having an at least electrically conductive covering and at a pressure raised compared with ambient pressure, e.g. for steering wheel heating purposes in motor vehicles.

Further advantages and characteristics of the invention can be gathered from the following description of embodiments and the attached drawings, wherein show:

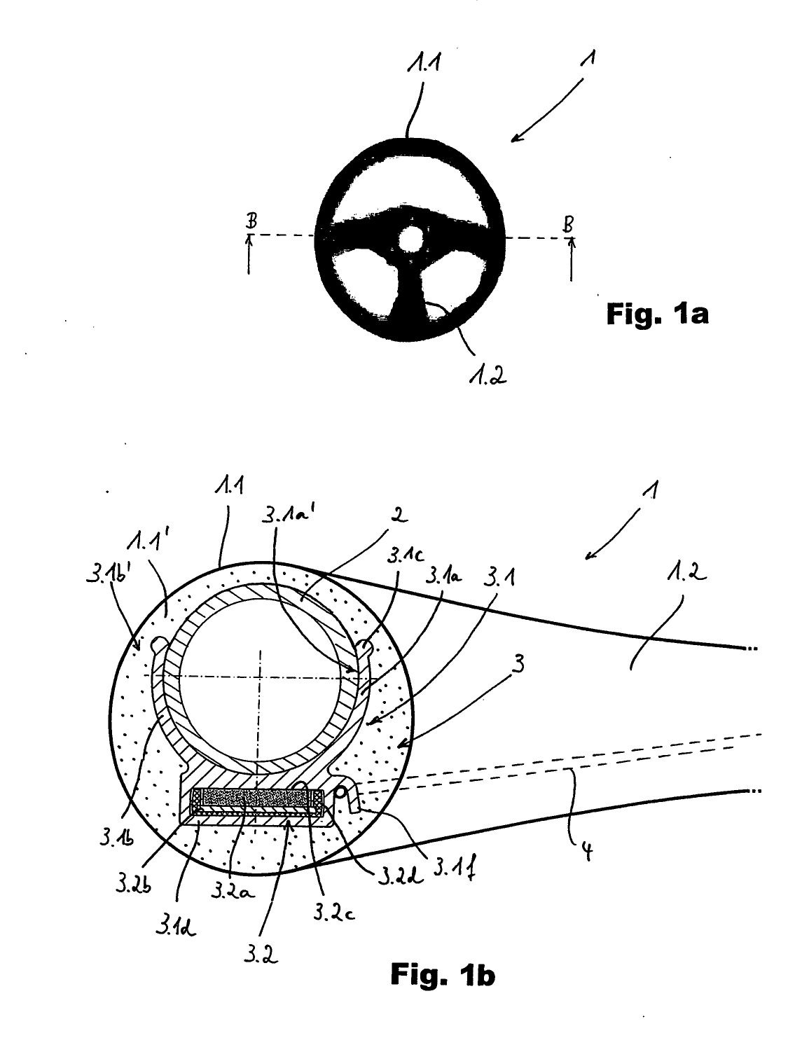

FIG. 1a A vehicle steering wheel as an example of an object to be temperature controlled by an inventive apparatus.

FIG. 1b A section through a vehicle steering wheel along line B-B of FIG. 1a with an inventive steering wheel heating apparatus.

FIG. 1c A detail view of a section according to FIG. 1b through a further development of an inventive apparatus.

FIG. 1d A section through an inventive arrangement of electrically insulating material, functional element and contact element prior to assembly.

FIG. 1e A further development of the inventive apparatus according to FIG. 1b.

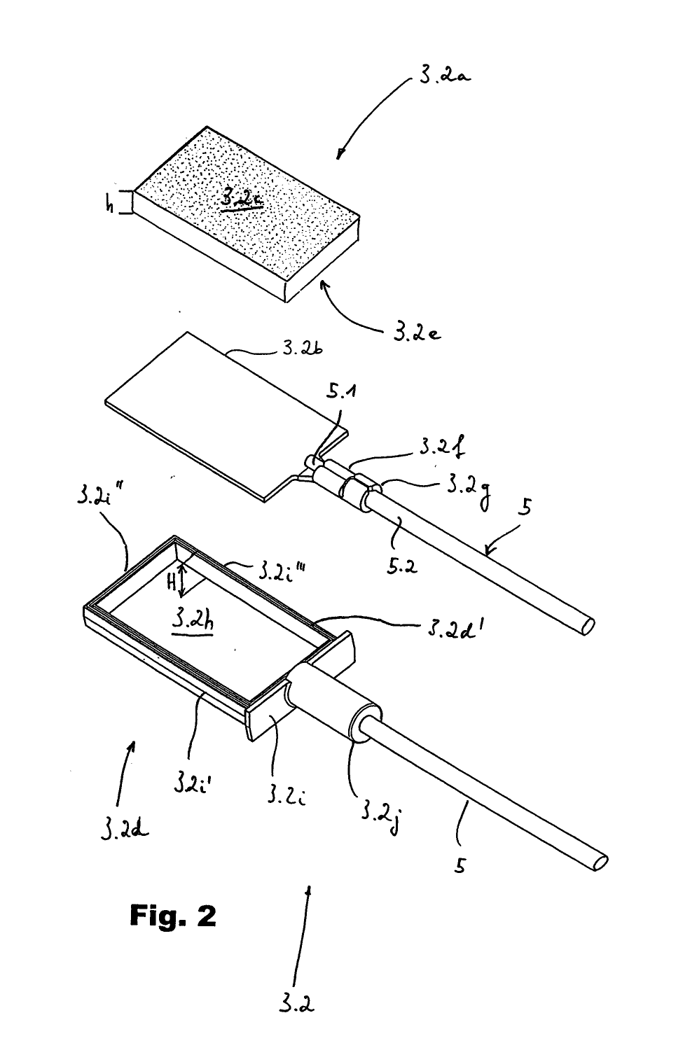

FIG. 2 A preferred development of an inventive temperature control device for an apparatus according to FIG. 1b prior to assembly.

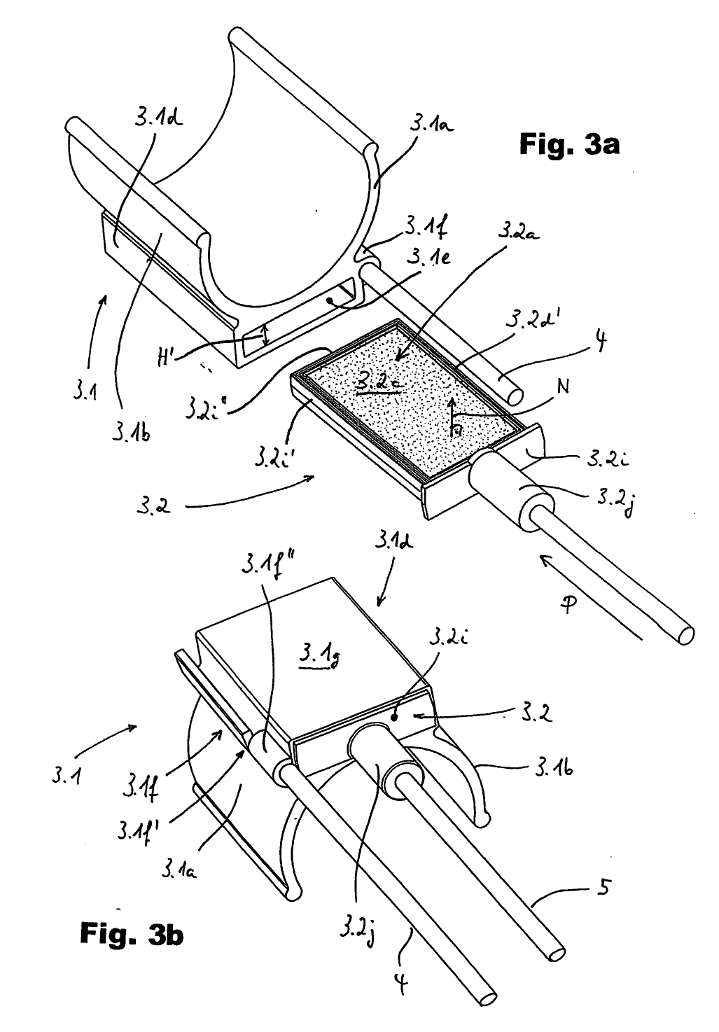

FIG. 3a The temperature control device of FIG. 2 prior to reception in an inventive fastening part or casing.

FIG. 3b The fastening part or casing and temperature control device in the assembled state.

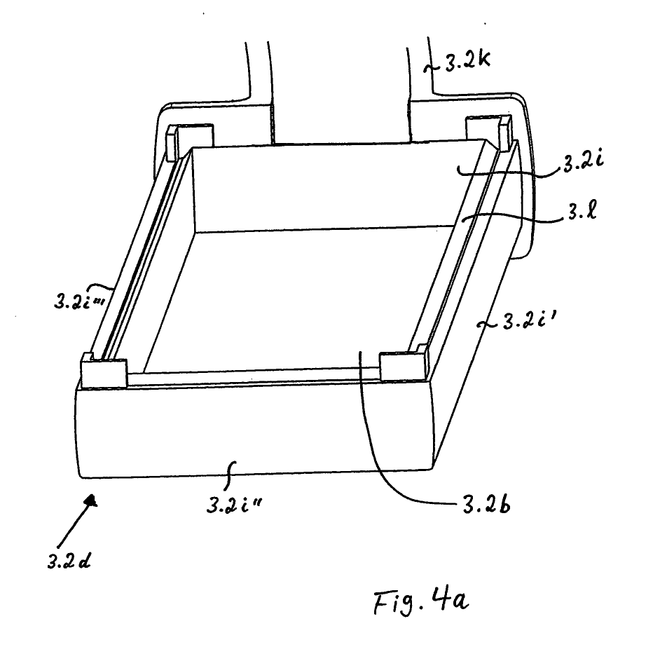

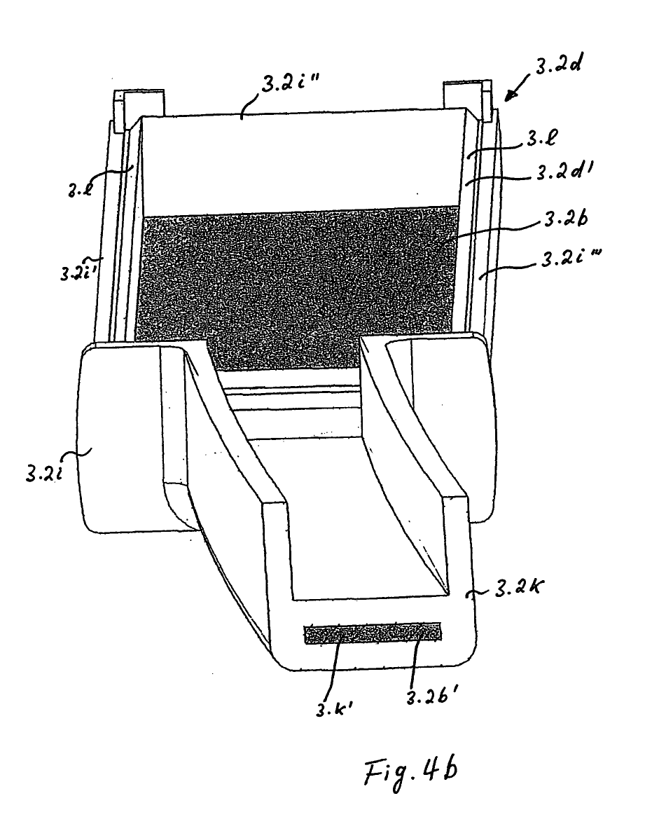

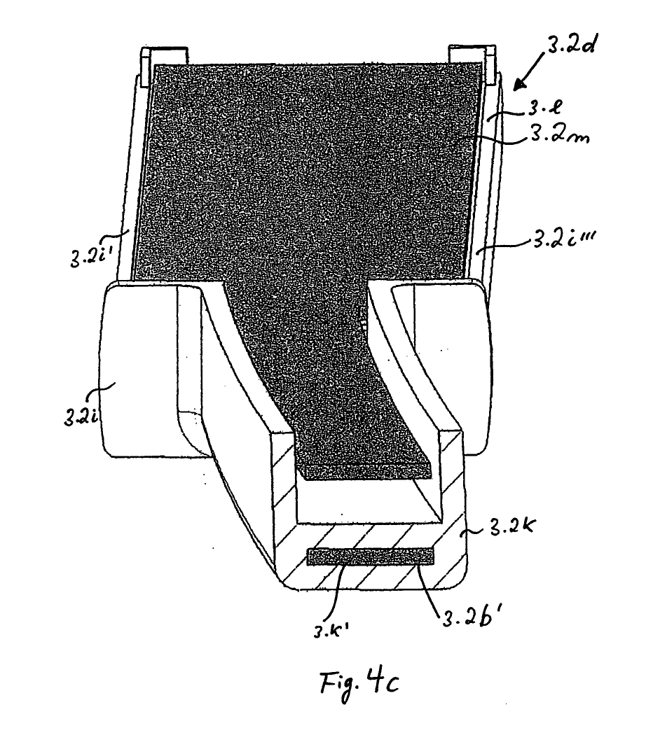

FIG. 4a-c Perspective views of a reception part for the PTC element (FIG. 4a, 4b) and following the insertion thereof (FIG. 4c).

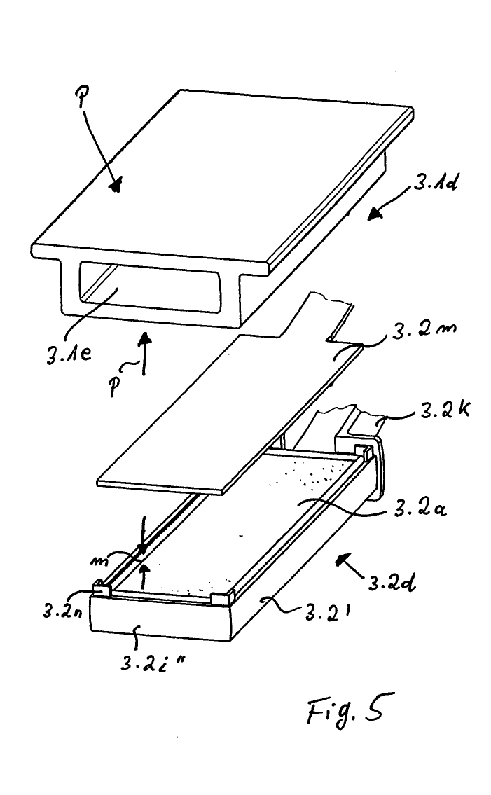

FIG. 5 An exploded view of a casing or casing-like part of a fastening part, an additional contact plate and the reception part with inserted PTC element.

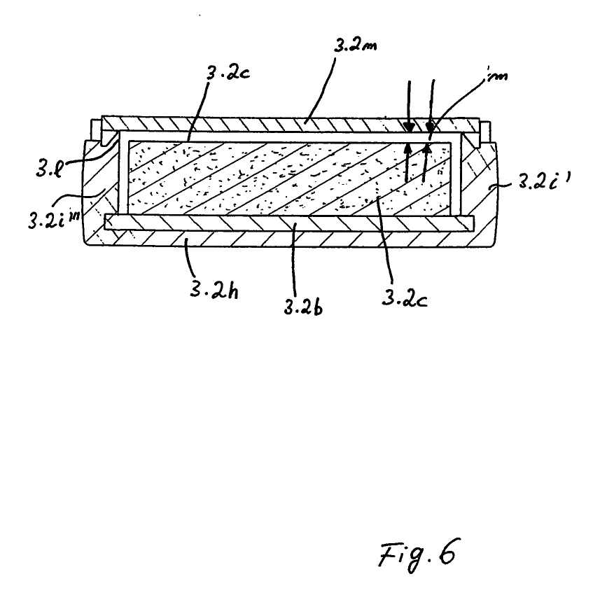

FIG. 6 A section through the contact arrangement with reception part, lower and upper contact plate and PTC element prior to extrusion.

FIG. 1a diagrammatically shows in exemplified manner a motor vehicle steering wheel 1 with ring 1.1 and a plurality of spokes 1.2. According to FIG. 1b a circumferential tube 2 is integrated into ring 1.1 and for heating the steering wheel can contain a suitable fluid, such as water or coolant. In addition, such a tube 2 can also be integrated into the spokes 1.2 of steering wheel 1, but this is not shown in FIG. 1.

As can be seen in FIG. 1b, on tube 2 is provided an inventive apparatus 3 with a fastening part 3.1 or casing 3.1d and a temperature control device in the form of a PTC heating device 3.2. The PTC heating device 3.2 is received in fastening part 3.1 or casing 3.1d and more precisely in a hollow reception part 3.1e of a casing 3.1d constructed with the fastening part. Tube 2, fastening part 3.1 and casing 3.1d and PTC heating device 3.2 are covered with a material 1.1′. Material 1.1′ has good heat conducting characteristics and is e.g. an elastic plastics material with a graphite or metal powder addition, which rapidly dissipates to the outside of the steering wheel the heat produced on PTC heating device 3.2. As a result of the aforementioned characteristics material 1.1′ also has a non-negligible electrical conductivity.

According to the invention, fastening part 3.1 and casing 3.1d is preferably also made from a good heating conducting material, such as a metal. Preferably it is an aluminium extruded section.

Fastening part 3.1 or casing 3.1d in the development of FIG. 1b is constructed in the form of a clip and has two pitch circular curved legs 3.1a, 3.1b. By means of legs 3.1a, 3.1b the fastening part 3.1 or casing 3.1d is held in force fit on tube 2. At the free end of each of the legs 3.1a, 3.1b there is a thickening 3.1c. The legs 3.1a, 3.1b cross-sectionally narrow towards their free end, which brings about a more uniform heat transfer and contact pressure between fastening part 3.1 or casing 3.1d and tube 2. In the preferred development of the fastening part 3.1 or casing 3.1d shown, as a result of a more than semicircular construction of the legs 3.1a, 3.1b (cf. the horizontal, dot-dash line in FIG. 1b) there is an elastic-resilient engagement of fastening part 3.1 or casing 3.1d on tube 2, so that the fastening part or casing can in simple manner be clipped onto tube 2. In addition, for bracing the fastening part 3.1 or casing 3.1d a not shown spring clip can be braced between the thickenings 3.1c of the leg ends functioning as holding means in order to increase the contact pressure of fastening part 3.1 or casing 3.1d on tube 2.

Between legs 3.1a and 3.1b and remote from their free ends fastening part 3.1 or casing 3.1d has a cross-sectionally substantially rectangular structure, in which is formed a cross-sectionally rectangular reception area 3.1e (cf. FIG. 3a) for receiving the temperature control device 3.2. In addition, structure 3.1d has a lateral, groove-like lug 3.1f (cf. FIG. 3a, b), which in the embodiment shown serves as an electrical connection means for an earth cable 4, i.e. for connecting fastening part 3.1 or casing 3.1d to a reference potential (earth potential).

Temperature control device 3.2 of inventive apparatus 3, according to FIG. 1b, has a PTC element 3.2a as the electrical functional element and a contact plate 3.2b at a potential different from earth and contacting the same as the contact element or contact means. In the shown assembled, specifically extruded state of fastening part 3.1 or casing 3.1d and temperature control device 3.2, the PTC element 3.2a contacts fastening part 3.1 or casing 3.1d on its side facing tube 2 by means of an upper contact surface 3.2c.

Accompanied by the hollowing out of surface 3.2c, a cross-sectionally U-shaped frame 3.2d of an electrical insulating material, such as plastic, preferably a liquid crystal polymer (LCP), PPS or polyamide is placed around PTC element 3.2a and contact plate 3.2b. Insulating frame 3.2d more particularly insulates contact plate 3.2b with respect to the fastening part 3.1 or casing 3.1d at earth potential.

FIG. 1b shows the inventive apparatus 3 in its assembled state, i.e. after temperature control device 3.2 has been inserted in fastening part 3.1 or casing 3.1d and has been non-positively connected thereto, e.g. by extrusion. It must in particular be ensured that also during the subsequent covering with the ring material 1.1′, e.g. by moulding or foaming round at a pressure increased compared with normal ambient pressure by a few bars, no conductive material 1.1′ of the steering wheel ring penetrates the inventive apparatus 3, particularly into an area between contact plate 3.2b and fastening part 3.1 or casing 3.1d at earth potential, whilst creating a shorting link. This function is fulfilled by the inventive construction of insulating frame 3.2d, subsequently described in greater detail relative to FIGS. 2 and 3a and also in a state prior to the assembly of the inventive apparatus 3.

FIGS. 1c-e represent detail views of further inventive developments of an apparatus in a representation according to FIG. 1b.

FIG. 1c shows an inventive arrangement with a PTC element 3.2a placed on a moulded round contact plate 3.2b within an insulating frame 3.2d. According to the invention this arrangement is introduced into the reception area 3.1e of fastening part 3.1 or casing 3.1d (cf. FIG. 1b). The fastening part 3.1 or casing 3.1d in its area engaging with contact surface 3.2c of PTC element 3.2a and insulating frame 3.2d a step 3.1h, so that a vertical clearance of reception area 3.1e below shoulder 3.1h is reduced compared with the height in the remaining zone of reception area 3.1e. In order to still ensure a reliable assembly and subsequent moulding of the inventive apparatus, account is taken of this state in that insulating frame 3.2d has a size corresponding to the height of the reception area 3.1e in the zone below shoulder 3.1h, so that the electrically insulating material of insulating frame 3.2d on all sides round contact surface 3.2c in a plane E parallel to the plane of the contact surface 3.2c engages on fastening part 3.1 or casing 3.1d.

FIG. 1d shows a cross-section through the above-described arrangement of insulating frame 3.2d, contact plate 3.2b and PTC element 3.2a, in which on its top insulating frame 3.2d has two parallel sealing lips 3.2d′, as is provided in a highly preferred development of the inventive apparatus.

FIG. 1e shows a further development of the inventive apparatus, in which the fastening part 3.1 or casing 3.1d is fixed by holding means 2.1, 2.2 provided on tube 2 and specifically in the form of cross-sectionally wing-like shoulders. Holding means 2.1, 2.2 of tube 2 engage over the free ends 3.1a′, 3.1b′ of legs 3.1a, 3.1b of fastening part 3.1 or casing 3.1d and hold the same positively and non-positively against the outer wall of tube 2, so that a reliable connection can be obtained with fastening part 3.1 or casing 3.1d and tube 2.

FIG. 2 shows in detail the structure of the temperature control device 3.2 of FIG. 1b in the unassembled state. The PTC element 3.2a is shown in a shallow, parallelepipedic form in the upper part of FIG. 2. PTC element 3.2a has an upper contact surface 3.2c for the release of thermal energy, as well as a lower, not visible surface 3.2e for an electrical connection to an electrical potential differing from earth. Contact surface 3.2c of PTC element 3.2a is connected to earth for operating PTC element 3.2a via fastening part 3.1 or casing 3.1d (cf. FIG. 1b), so that an operating voltage is applied via PTC element 3.2a.

Below PTC element 3.2a is shown contact plate 3.2b without insulating frame 3.2d, which in the assembled state of the inventive temperature control device 3.2 engages on the underside 3.2e of PTC element 3.2a. Contact plate 3.2b is connected to a potential differing from earth by a cable 5 as the potential-carrying lead, which forms an electrical connection for functional element 3.2a. According to FIG. 2 the contact plate 3.2b also has connection means 3.2f together with which it inventively forms the assembled connection and contact means and a tension relief 3.2g for crimping in cable 5. For potential connection purposes a two-part (connecting means 3.2f and tension relief 3.2g) wire end sleeve is integrally shaped onto contact plate 3.2b and by means of which, advantageously in a single operation, firstly a stripped part 5.1 of cable 5 is electrically conductively crimped (clamped) to contact plate 3.2b and an insulated part 5.2 of cable 5 is also crimped to contact plate 3.2b.

In the lower part of FIG. 2 can be seen contact plate 3.2b in insulating frame 3.2d shown in FIG. 1b. In the embodiment shown it is formed by integral moulding round the inventive connection and contact means 3.2b, 3.2f in the form of contact plate 3.2b together with their connection means 3.2f and tension relief 3.2g with an electrically insulating material and in particular insulates contact plate 3.2b against fastening part 3.1 or casing 3.1d. Insulating frame 3.2d has a “drawer form” for positioning the subsequently inserted PTC element 3.2a with bottom 3.2h and side walls 3.2i-3.2i″′ and the side wall 3.2i located at connection means 3.2f in the manner of a panel projects in both width and height over the remaining side walls 3.2i′-3.2i′″. In an integral connection with the front side wall 3.2i in the embodiment shown the insulating frame 3.2d has a sleeve-like lug 3.2j inventively surrounding contact means 3.2f and tension relief 3.2g for cable 5. A height H of side walls 3.2i′-3.2i′″ exceeds a corresponding dimension h of PTC element 3.2f so as to project over said PTC element in the manner of a circumferential sealing lip 3.2d′. However, it is also possible to have several, preferably two parallel sealing lips.

In place of the panel-like side wall 3.2i, it is possible to merely have individual, not shown lugs on the end face (side wall 3.2i) of insulating frame 3.2d, which define an end position on inserting temperature control device 3.2 into fastening part 3.1 or casing 3.1d (cf. FIG. 1b, 3b).

FIG. 3a is a perspective view of fastening part 3.1 or casing 3.1d and the assembled temperature control device 3.2 prior to the insertion of the latter in a reception area 3.1e in fastening part 3.1 or casing 3.1d, which has a vertical clearance H′. As can be seen in FIG. 3a, as stated, side walls 3.2i-3.2′″ project over contact surface 3.2c of PTC element 3.2a located in insulating frame 3.2d and this extends over their entire circumference in the manner of a sealing lip in the direction of a surface normal N of contact surface 3.2c.

Following the drawer-like insertion of temperature control device 3.2 in fastening part 3.1 or casing 3.1d, extrusion takes place e.g. by pressure action on a bottom 3.1g of structure 3.1d of fastening part 3.1 or casing 3.1d (FIG. 3b). The inventive temperature control device 3.1 is inserted in the direction of arrow P in fastening part 3.1 or casing 3.1d. As a result of extrusion, combined with a decrease in the vertical clearance H′ of reception area 3.1e (FIG. 3a), the sealing lip 3.2d′ of insulating frame 3.2d is preferably elastically deformed until contact surface 3.2c engages on fastening part 3.1 or casing 3.1d (and the inside of bottom 3.1g on bottom 3.2h—FIG. 2—of insulating frame 3.2d). Thus, functional element 3.2a with its connection and contact means 3.2b, 3.2f in conjunction with connecting cable 5 is protected over the entire circumference of contact surface 3.2c against the penetration of conductive material 1.1′ during a subsequent covering of the inventive apparatus 3 with the material 1.1′ of steering wheel ring 1.1 (FIG. 1a, b). A further extending protective function results from the front side wall 3.2i of insulating frame 3.2d projecting in panel-like, all-round manner over the opening of reception area 3.1e and which additionally prevents a penetration of material into reception area 3.1e of fastening part 3.1 or casing 3.1d, particularly if the reception area is constructed in an all-round closed form, apart from said opening.

The fixing of earth cable 4 to fastening part 3.1 or casing 3.1d, according to FIG. 3b, takes place by partial bending round (rolling in) of a part 3.1f″, defined by a slot 3.1f′ of shoulder 3.1f of fastening part 3.1 or casing 3.1d. Alternatively the fixing of earth cable 4 can also take place in a central area of shoulder 3.1f and this correspondingly has two slots 3.1f′.

A further inventive development of a temperature control device or an apparatus with such a device and parts thereof are shown in FIG. 4a-6. To the extent that they show identical parts, they are given the same reference numerals as in the previously described drawings and to this extent reference is made thereto.

FIG. 4a is a perspective rear view from rear wall 3.2i″ of a frame or reception part 3.2d, on whose bottom rests a contact and connection plate 3.2b, which has a cover plate 3.2b′, which is led to the outside through a lug 3.2k comparable to sleeve 3.2j (FIG. 4b, 4c). In FIGS. 4b and 4c the reception part 3.2d is shown in a perspective front view from the front wall 3.2i or a lug 3.2k emanating therefrom. FIG. 4b also shows reception part 3.2d with a merely inserted contact plate 3.2b, whereas in FIG. 4c the not visible PTC element is inserted and on it is placed a further contact plate 3.2m, which is held in place by angular projections 3.2n on the top of the reception part. FIG. 6 is a cross-section through the development of FIG. 4c.

Connection plate 3.2b with its cover plate 3.2b′ can be moulded round by reception part 3.2d or with the opening 3.k′ in shoulder 3.2k can be subsequently inserted from the top of rear wall 3.2i′ in such a way that the cover plate 3.2b′ is shoved through opening 3.k′.

In the represented embodiment of FIG. 4a-4c, on their upper edge side walls 3.2i-3.2i″′ have a circumferential lip 3.1, which circumferentially tapers towards its free end. Following insertion of PTC element 3.2a, lip 3.1 projects over the top 3.2c of PTC element 3.2a by a dimension m, which is shown larger in FIG. 6.

In order to produce the assembled apparatus 3 two possibilities exist. Either the casing 3.1d has a reception area 3.1e, whose inside cross-section and in particular its height is such that the arrangement shown in FIG. 4c, 6 can be inserted without difficulty into the reception area and then extrusion takes place perpendicular to PTC element surface 3.2c, i.e. arrows P in FIG. 5. The temperature control device shown in FIGS. 4c and 6 is extruded beforehand in such a way that it can be inserted into a reduced height cavity 3.1e.

In the installed state an extrusion of the temperature control device takes place in such a way that lips 3.1 are deformed and upper contact plate 3.2 engages firmly and under pressure on the top 3.2c of PTC element 3.2a, so that there is both a good electrical contact and also a good thermal contact over the upper contact plate 3.2m.

Thus, according to the invention, electrical functional elements, such as the PTC element shown, can be protected against the occurrence of short-circuits during a subsequent enveloping with an electrically conductive material. When the apparatus 3 according to the invention (FIG. 1b) is used in a steering wheel 1 of a motor vehicle a steering wheel heating can be brought about. As a result of the simple design and production of the present invention, the steering wheel heating has in particular advantageous manufacturing costs, so that its use is not limited to top quality cars.

### REFERENCE NUMERALS LIST

1 Steering wheel

1.1 Ring

1.2 Spoke

1.1′ Ring material

2 Tube

2.1, 2.2 Holding means

3 Assembled apparatus

3.k′ Opening

3.1 Lip

3.1a, 3.1b Leg

3.1a′, 3.1b′ Free end

3.1c Thickening

3.1d Casing

3.1e Reception area

3.1f Shoulder

3.1f′ Slot

3.1f″ Partial area

3.1g Bottom

3.1h Shoulder

3.2 Temperature control/PTC heating device

3.2a PTC element

3.2b Connection plate

3.2b′ Cover

3.2c Contact surface

3.2d Insulating frame

3.2d′ Sealing lip

3.2e Underside

3.2f Connection means

3.2g Tension relief

3.2h Bottom

3.2i-3.2i″′ Side wall

3.2j Sleeve

3.2k Lug

3.2m Contact plate

3.2n Angular projections

4 Earth cable

5 Cable

5.1 Stripped area

5.2 Insulated area

E Plane

h Height

H, H′ Height

P Movement direction

1-44. (canceled)

45. A method for electrical insulation of an arrangement having at least one electrical functional element, a PTC heating functional element, or a thermoelectric functional element, which is disposed on an electrically conductive fastening part or in an electrically conductive casing, the functional element having at least one electrical connection insulated from the fastening part, the method comprising the step of:
surrounding the functional element and the at least one connection with an electrically insulating material which engages around a contact surface on the fastening part or in the casing while leaving open at least one contact surface to the fastening part.

46. A method for the electrical insulation of an arrangement having at least one electrical functional element, a PTC heating functional element, or a thermoelectric functional element, which is disposed on an electrically conductive fastening part or in an electrically conductive casing, the element having at least one electrical connection insulated from the fastening part, the method comprising the steps of:
placing a contact plate over the functional element to engage on the fastening part or in the casing; and
surrounding the functional element and the at least one connection with an electrically insulating material which sealingly engages about the functional element on the contact plate while leaving open at least one contact surface to the fastening part.

47. The method of claim 46, wherein the contact surface is part of a functional element surface.

48. The method of claim 47, wherein the contact surface is disposed on a side of the contact plate remote from the functional element.

49. The method of claim 45, wherein the arrangement or the functional element is placed in a hollow reception area of the fastening part or casing.

50. The method of claim 45, wherein prior to assembly of the functional element or prior to assembly of the functional element on the fastening part or in the casing, the electrically insulating material projects beyond the entire circumference of the contact surface or functional element.

51. The method of claim 50, wherein the electrically insulating material projects beyond the contact surface or functional element in a direction of a surface normal thereof.

52. The method of claim 45, wherein the electrically insulating material is moulded about a functional element contact element connected to the electrical connection.

53. The method of the claim 45, wherein the electrically insulating material is moulded about the electrical connection.

54. The method of claim 51, wherein the electrically insulating material is moulded about the electrical connection, the contact element and electrical connection being integrally surrounded by moulded electrically insulating material.

55. The method of claim 52, wherein the functional element is introduced into the contact element and/or the at least one connection together with the moulded insulating material.

56. The method of claim 45, wherein the functional element together with at least the surrounding insulating material is introduced into a reception area in the fastening part or casing.

57. The method of claim 45, wherein the functional element is clamped together with at least the surrounding insulating material and the fastening part or casing.

58. The method of claim 45, wherein the electrically insulating material engaging the fastening part or casing is at least partly elastically deformed during assembly of the functional element or during assembly of the functional element on the fastening part.

59. A temperature control device comprising:
a thermal functional element having a contact surface;
an electrical connection with contact means, connected to said thermal functional element; and
an electrically insulating material surrounding said contact surface in a plane parallel thereto to form at least one sealing lip extending over an entire circumference of said contact surface, wherein said electrically insulating material surrounds said thermal functional element and said connection and contact means but does not cover said contact surface.

60. The device of claim 59, wherein said contact surface is part of a functional element surface.

61. The device of claim 59, wherein said sealing lip sealingly engages on a contact plate covering said functional element.

62. The device of claim 59, wherein said contact surface is disposed on a side of a contact plate which is remote from said functional element.

63. The device of claim 59, wherein said electrically insulating material projects beyond an entire circumference of said contact surface or of said functional element.

64. The device of claim 63, wherein said sealing lip projects beyond said contact surface or said functional element substantially in a direction of a surface normal thereof.

65. The device of claim 59, wherein said sealing lip is at least partly elastically deformable.

66. The device of claim 59, wherein said thermal functional element and said connection and contact means are integrally surrounded by said electrically insulating material.

67. The device of claim 59, wherein at least said sealing lip is made from a plastic material.

68. The device of claim 67, wherein said plastic material is a liquid crystal polymer.

69. The device of claim 59, wherein said thermal functional element is a PTC heating element.

70. An apparatus having the temperature control device of claim 59, further comprising a fastening part or a casing for bringing the temperature control device into operative connection with an object being temperature controlled.

71. The apparatus of claim 70, wherein said functional element is placed in a reception area of said fastening part or casing.

72. The apparatus of claim 71, wherein said fastening part or casing is made from a material having good heat conducting properties.

73. The apparatus of claim 72, wherein said fastening part or casing has a reception area for the temperature control device.

74. The apparatus of claim 73, wherein the temperature control device is substantially completely surrounded by said fastening part, with exception of a reception opening, after reception in said fastening part or casing.

75. The apparatus of claim 70, wherein the temperature control device and said fastening part or casing are connectable or clamped with one another.

76. The apparatus of claim 75, wherein a connection between the temperature control device and said fastening part or casing is sealed against pressure in excess of ambient pressure.

77. The apparatus of claim 70, wherein said fastening part or casing is a clip.

78. The apparatus of claim 70, wherein the fastening part or casing has first and second legs for at least partial embracing an object to be connected to the apparatus.

79. The apparatus of claim 78, wherein said legs are constructed in a substantially semi-circular manner.

80. The apparatus of claim 78, wherein said legs taper towards free ends thereof.

81. The apparatus of claim 70, wherein said fastening part or casing can be placed in force fit on an object to be connected to the apparatus.

82. The apparatus of claim 78, wherein a free end of each of said legs has a holding means for a clamping means to fix said fastening part or casing to an object to be connected to the apparatus.

83. The apparatus of claim 78, wherein said fastening part or casing can be fixed to the object by clamping said legs thereon.

84. The apparatus of claim 70, wherein said fastening part or casing can be fixed to the object by holding means provided on the latter.

85. The apparatus of claim 70, wherein said fastening part or casing has a connection means for further electrical connecting means to connect to a reference potential.

86. Use of the apparatus of claim 70, for heating a fluid carried in a tubular conduit.

87. Use of the apparatus of claim 70, for heating a fluid carried at a pressure higher than ambient pressure in a tube having an electrically conductive covering.

88. Use of the apparatus of claim 70, for heating a steering wheel in motor vehicles.
